(19) United States
(12) Patent Application Publication
(10) Pub. No.: US 2025/0088233 A1
(43) Pub. Date: Mar. 13, 2025

(54) COMMUNICATION DEVICE, METHOD, AND RECORDING MEDIUM

(71) Applicant: NEC Corporation, Minato-ku, Tokyo (JP)

(72) Inventor: Motoya IWASAKI, Tokyo (JP)

(73) Assignee: NEC Corporation, Minato-ku, Tokyo (JP)

(21) Appl. No.: 18/729,701

(22) PCT Filed: Feb. 28, 2022
(86) PCT No.: PCT/JP2022/008235

§ 371 Date: Jul. 17, 2024

(51) Int. Cl. H04B 7/06; H04L 25/02

(52) U.S. Cl. CPC H04B 7/0617; H04L 25/0202

(57) ABSTRACT

A first communication device is the first communication device among the first communication device and a second communication device that are connected to each other via an interface and to which base station functions are distributed, the second communication device includes a beamforming weight calculation unit and a channel estimation unit, and the first communication device includes a scheduler configured to transmit, to the second communication device via the interface, information related to a reference signal to be transmitted from a terminal device, receive, via the interface, a channel estimation value related to a channel between the terminal device and the second communication device, being calculated by the second communication device by using a reception reference signal associated with information related to the reference signal, and determine a resource to be allocated to communication with the terminal device, based on the channel estimation value.

### TECHNICAL FIELD

The present invention generally relates to a mobile communication network.

### BACKGROUND ART

In recent years, in a mobile communication network employing new radio (NR), a base station (BS) is divided into several devices. For example, a base station employing NR is divided into a centralized unit (CU), a distributed unit (DU), and a radio unit (RU). Among these units, for example, the CU hosts a packet data convergence protocol (PDCP) layer. In addition, for example, the DU hosts a radio link control (RLC) layer, a media access control (MAC) layer, and some higher-level layers (high PHY layers) of physical (PHY) layers. Further, for example, the RU hosts some lower-level layers (low PHY layers) of the PHY layers. Further, the DU and the RU are connected through an interface referred to as a fronthaul. Note that the DU is also referred to as a digital device, and the RU is also referred to as a wireless device. In addition, efforts toward an open radio access network (Open RAN) that, when configuring a base station from devices such as the CU, the DU, and the RU, configures the base station by combining devices from different vendors are accelerated. Use of Open RAN allows for a more flexible combination of CUs, DUs, RUs, etc. that are conventionally provided by a single vendor. Currently, the “O-RAN Alliance”, an industrial organization, plays a central role in formulation of O-RAN specifications being one of Open RAN specifications. In a case of a RAN architecture employing the O-RAN, a DU employing the O-RAN may be referred to as an O-DU, and an RU employing the O-RAN may be referred to as an O-RU. For example, NPL 1 describes an O-RAN, an O-DU, or an O-RU architecture. Furthermore, PTL 1 describes a method for arranging various functional units into DUs and RUs.

In addition, as communication terminals (e.g., user equipment (UE)) explosively increase, it has become common to use beamforming techniques using large-scale array antennas provided in a base station. Effective use of beamforming techniques enables high-speed and large-capacity wireless communication in NR. For example, in order for a base station divided into a CU, a DU, and an RU to perform communication using beamforming, for example, a beamforming technique described in NPL 2 is used.

### CITATION LIST

### Patent Literature

PTL 1: International Patent Publication No. WO2018/173891

### Non Patent Literature

NPL 1: O-RAN Fronthaul Control, User and Synchronization Plane Specification 7.0-July 2021, <https://www.o-ran.org/specifications>
NPL 2: Takeda, Kazuaki, and 5 persons, “Study status on physical layer element technique and high frequency band use in 5G”, NTT DOCOMO Technical Journal, Vol. 25, No. 3, 2017 October, <https://www.nttdocomo.co.jp/binary/pdf/corporate/technology/rd/technic al_journal/bn/vol25_3/vol25_3_005jp.pdf>

### SUMMARY OF INVENTION

### Technical Problem

The inventor has studied various technical contents including the above-described cited documents, in particular, a method related to separation to a first communication device and a second communication device each having a base station function, and found the following problems. Specifically, depending on how a plurality of functions related to beamforming in the base station are distributed to the first communication device and the second communication device, and information exchanged between the first communication device and the second communication device in association therewith, an amount of information of a control signal being exchanged between the first communication device and the second communication device increases. As a result, an interface having a very large band needs to be provided between the first communication device and the second communication device.

### Solution to Problem

A communication device according to a first aspect of the present disclosure is a first communication device among the first communication device and a second communication device that are connected to each other via an interface and to which base station functions are distributed, the second communication device includes a beamforming weight calculation unit and a channel estimation unit, and the first communication device includes a scheduler configured to: transmit, to the second communication device via the interface, information related to a reference signal to be transmitted from a terminal device; receive, via the interface, a channel estimation value related to a channel between the terminal device and the second communication device, being calculated by the second communication device by using a reception reference signal associated with information related to the reference signal; and determine a resource to be allocated to communication with the terminal device, based on the channel estimation value.

A communication device according to a first aspect of the present disclosure is a second communication device among a first communication device and the second communication device that are connected to each other via an interface and to which base station functions are distributed, the second communication device including: a channel estimation unit configured to receive, from the first communication device via the interface, information related to a reference signal to be transmitted from a terminal device and calculate a channel estimation value related to a channel between the terminal device and the second communication device by using a reception reference signal associated with information related to the reference signal; and a beamforming weight calculation unit configured to calculate, based on the calculated channel estimation value, a beamforming weight to be used for communication with the terminal device.

A method according to a first aspect of the present disclosure is a method of a first communication device among the first communication device and a second communication device that are connected to each other via an interface and to which base station functions are distributed, the second communication device includes a beamforming weight calculation unit and a channel estimation unit, and the method includes: transmitting, to the second communication device via the interface, information related to a reference signal to be transmitted from a terminal device; receiving, via the interface, a channel estimation value related to a channel between the terminal device and the second communication device, being calculated by the second communication device by using a reception reference signal associated with information related to the reference signal; and determining a resource to be allocated to communication with the terminal device, based on the channel estimation value.

A method according to a first aspect of the present disclosure is a method of a second communication device among a first communication device and the second communication device that are connected to each other via an interface and to which base station functions are distributed, and the method includes: receiving, from the first communication device via the interface, information related to a reference signal to be transmitted from a terminal device; calculating a channel estimation value related to a channel between the terminal device and the second communication device by using a reception reference signal associated with information related to the reference signal; and calculating, based on the calculated channel estimation value, a beamforming weight to be used for communication with the terminal device.

A recording medium according to a first aspect of the present disclosure is a computer-readable recording medium storing a program of a first communication device among the first communication device and a second communication device that are connected to each other via an interface and to which base station functions are distributed, the second communication device includes a beamforming weight calculation unit and a channel estimation unit, and the program enables execution of: transmitting, to the second communication device via the interface, information related to a reference signal to be transmitted from a terminal device; receiving, via the interface, a channel estimation value related to a channel between the terminal device and the second communication device, being calculated by the second communication device by using a reception reference signal associated with information related to the reference signal; and determining a resource to be allocated to communication with the terminal device, based on the channel estimation value.

A program according to a first aspect of the present disclosure is a program of a second communication device among a first communication device and the second communication device that are connected to each other via an interface and to which base station functions are distributed, and the program enables execution of: receiving, from the first communication device via the interface, information related to a reference signal to be transmitted from a terminal device; calculating a channel estimation value related to a channel between the terminal device and the second communication device by using a reception reference signal associated with information related to the reference signal; and calculating, based on the calculated channel estimation value, a beamforming weight to be used for communication with the terminal device.

### Advantageous Effects of Invention

According to the present disclosure, it is possible to provide a communication device and a method that are capable of reducing an amount of information of a control signal related to beamforming to be exchanged between devices. Note that this advantageous effect is merely one of a plurality of advantageous effects that the example embodiments disclosed herein are intended to achieve. Other effects become apparent from description of the present description or the accompanying drawings.

### BRIEF DESCRIPTION OF DRAWINGS

FIG. 1 is an explanatory diagram for describing an example of a communication device 1 according to a first example embodiment.

FIG. 2 is an explanatory diagram for describing an example of a communication device 2 according to the first example embodiment.

FIG. 3 is an explanatory diagram for describing an example of a communication device 3 according to the first example embodiment.

FIG. 4 is a sequence diagram for describing an operation example of the communication device 2 according to the first example embodiment.

FIG. 5 is an explanatory diagram for describing an example of the communication device 2 according to the first example embodiment.

FIG. 6 is an explanatory diagram for describing an example of a communication device 5 according to a second example embodiment.

FIG. 7 is an explanatory diagram for describing an example of a communication device 6 according to the second example embodiment.

FIG. 8 is a sequence diagram for describing an operation example of a communication device 7 according to the second example embodiment.

FIG. 9 is a sequence diagram for describing an operation example of the communication device 6 according to a third example embodiment.

FIG. 10 is an explanatory diagram for describing a configuration example of a communication device according to each example embodiment.

### EXAMPLE EMBODIMENT

Hereinafter, specific example embodiments are described in detail with reference to the drawings. In the drawings, the same or corresponding element is denoted by the same reference sign, and redundant description is omitted as necessary in order to simplify the description.

The following example embodiments may be implemented independently or in combination as appropriate. The plurality of example embodiments have novel features that are different from one another. Therefore, the plurality of example embodiments contribute to solving different objects or problems, and contribute to achieving effects different from one another.

As used in the present description, depending on the context, “if” may be interpreted to mean “when”, “at or around the time”, “after”, “upon”, “in response to determining”, “in accordance with a determination”, or “in response to detecting”. These expressions may be interpreted as having the same meaning depending on the context.

### First Example Embodiment

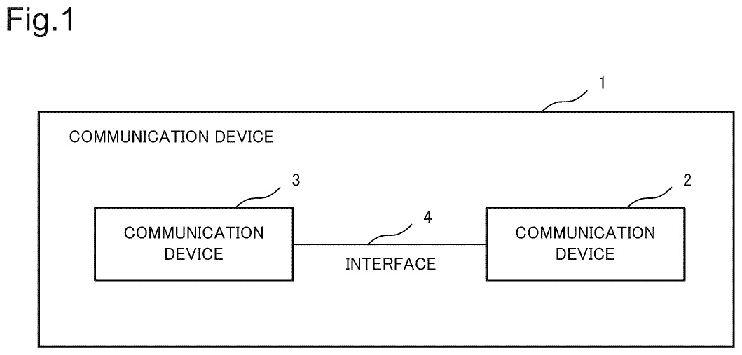

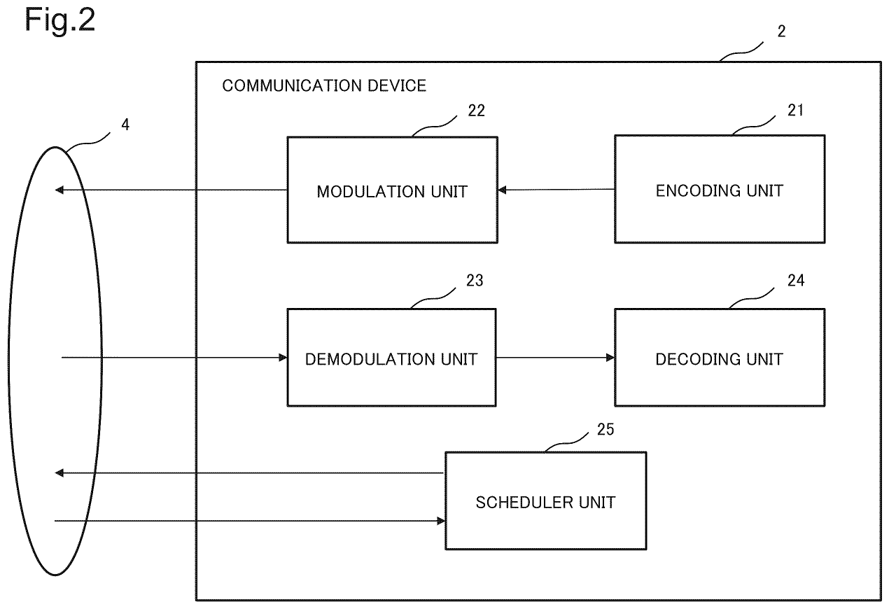

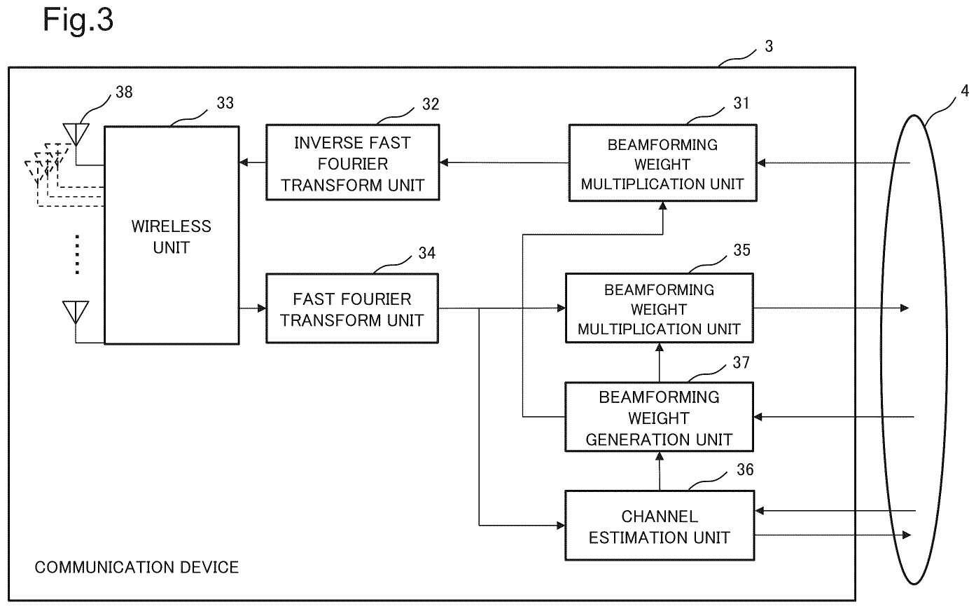

FIG. 1 illustrates a configuration example of a communication device 1 according to the present example embodiment, FIG. 2 illustrates a configuration example of a communication device 2 according to the present example embodiment, and FIG. 3 illustrates a configuration example of a communication device 3 according to the present example embodiment. For example, the communication device 1 may be a base station that supports a communication scheme defined in third generation partnership project (3GPP) such as long term evolution (LTE) and new radio (NR).

The communication device 1 includes the communication device 2 and the communication device 3. The communication device 2 serves as a first communication device, and the communication device 3 serves as a second communication device. As described above, for example, since the communication device 1 is a base station, all or a part of the functions of the base station are distributed in the communication device 2 and the communication device 3. Note that, the communication device 1 may include other communication devices in addition to the communication device 2 and the communication device 3. In other words, the functions of the base station may be distributed among a plurality of communication devices including the communication device 2 and the communication device 3. The base station is connected to, for example, a terminal device and a core network that support LTE and NR. The base station and the core network are connected by an S1 interface or an NG interface, and the base stations are connected by an X2 interface or an Xn interface, but the present invention is not limited thereto.

A base station employing NR is divided into, for example, a centralized unit (CU), a distributed unit (DU), and a radio unit (RU). Among these units, for example, the CU hosts a packet data convergence protocol (PDCP) layer. In addition, for example, the DU hosts a radio link control (RLC) layer, a media access control (MAC) layer, and some higher-level layers (high PHY layers) of physical (PHY) layers. Further, for example, the RU hosts some of lower-level layers (low PHY layers) of the PHY layers. Further, the DU and the RU are connected through an interface referred to as a fronthaul. The CU and the DU are also connected through an interface.

For example, the communication device 2 may be an O-DU (or DU) defined by the O-RAN Alliance, and the communication device 3 may be an O-RU (or RU) defined by the O-RAN Alliance. The communication device 2 and the communication device 3 are connected through an interface 4. The interface 4 may be an open fronthaul defined by the O-RAN Alliance. Needless to say, the communication device 2, the communication device 3, and the interface 4 are not limited thereto. For example, the communication device 2, the communication device 3, and the interface 4 may be devices or interfaces defined by 3GPP. For example, the communication device 2 may be a DU, the communication device 3 may be an RU, and the interface 4 may be a fronthaul. The other communication devices included in the communication device 1 in addition to the communication device 2 and the communication device 3 may be CUs. The interface connecting the CU and the communication device 2 may be an F1 interface.

In FIG. 2, the communication device 2 includes an encoding unit 21, a modulation unit 22, a demodulation unit 23, a decoding unit 24, and a scheduler unit 25. The communication device 2 may additionally include a reception unit configured to receive data from the interface 4 and higher-level devices, and a transmission unit configured to transmit data to the interface 4 and higher-level devices.

The encoding unit (COD) 21 of the communication device 2 encodes transmission data directed to a terminal device (hereinafter, may be referred to as a “target terminal device”) of a communication counterpart scheduled by the scheduler unit 25, and outputs the encoded transmission data to the modulation unit 22. The number of target terminal devices in a single timing is not particularly limited, and there may be one or a plurality of target terminal devices. In the following description, for the sake of simplicity, a case where there is only one target terminal device in a single timing is described as one example.

The transmission data may be, for example, downlink data (user plane, U-Plane) or control plane (C-Plane) signals from higher-level devices. The higher-level device may be a CU connected through an interface. The interface is, for example, an F1-U interface or an F1-C interface.

The modulation unit 22 of the communication device 2 modulates the transmission data received from the encoding unit 21, and outputs the acquired modulation signal. The modulation signal may be, for example, an IQ sample sequence associated with L (L is a natural number) layers. The modulation signal of each layer may also be referred to as a transmission sequence. That is, L transmission sequences are output from the modulation unit 22.

The modulation signal output from the modulation unit 22 is transferred to the communication device 3 via the interface 4. At this time, a message format for transmitting/receiving a modulation signal between the communication device 2 and the communication device 3 may be used.

The demodulation unit (DEM) 23 of the communication device 2 receives a reception signal from the communication device 3, which is described later, via the interface 4. The reception signal being received from the communication device 3 may be, for example, an IQ sample sequence associated with M (M is a natural number) layers. The reception signal of each layer may also be referred to as a reception sequence. That is, the demodulation unit (DEM) 23 receives the M reception sequences from the communication device 3. The demodulation unit acquires reception data by demodulating the M reception sequences, and outputs the reception data to the decoding unit 24.

The decoding unit 24 decodes the reception data received from the demodulation unit 23, and outputs the data after the decoding process. The data after the decoding process may be transmitted to a higher-level device connected through an interface. The higher-level device may be the same as the higher-level device to which the encoding unit 21 is connected.

The scheduler unit 25 generates first wireless resource allocation information, based on the state of a terminal device to be connected to the communication device 1 or the communication device 3. For example, the scheduler unit 25 may determine whether the terminal device requests for communication with the communication device 1 or the communication device 3, or whether the terminal device is waiting for communication from the communication device 1 or the communication device 3, and generate the first wireless resource allocation information. In addition, the scheduler unit 25 transmits the first wireless resource allocation information to a channel estimation unit 36 of the communication device 3 through the interface 4.

Herein, the first wireless resource allocation information is described. The first wireless resource allocation information is information necessary for the communication device 3 to perform channel estimation using a reference signal included in the reception signal received from the terminal device, and includes, for example, allocation information related to the terminal device in the wireless resource of the reference signal. More specifically, the allocation information related to the terminal device is, for example, information indicating which wireless resource in the reception signal includes the reference signal of the target terminal device. Note that, the reference signal is a signal to be referred to when the base station measures channel quality of a propagation path with the terminal device, reception timing of a signal from the terminal device, and the like. The reference signal is included in a reception signal received from the terminal device. For example, the reference signal is a sounding reference signal (SRS). Alternatively, the reference signal may be, but is not limited to, a demodulation reference signal (DMRS, DM-RS).

For example, the first wireless resource allocation information includes a “first parameter group” being used to calculate a resource (for example, time-frequency resource) to which the reference signal is mapped, and a “second parameter group” being used to calculate a pattern of the reference signal.

The “first parameter group” includes, for example, a symbol number 1 in the time-axis slot, a frequency-starting position k₀, and a bandwidth N_{BW}. The “second parameter group” includes, for example, a transmission comb number K_{TC}, a cyclic shift number n_{CS}, and hopping coefficients u and v. Note that the frequency-starting position k₀ may be referred to as a subcarrier number. The transmission comb number K_{TC} is any value among 2, 4, and 8, for example. In addition, the cyclic shift number n_{CS} is any value among 0, 1, 2, . . . . N_{CS}−1, for example. Note that N_{CS} is the cyclic shift maximum value described later. Further, the hopping coefficient u is any value among 0, 1, 2 . . . 29, for example, and the hopping coefficient v is either 0 or 1, for example. The bandwidth N_{BW} may be in units of resource blocks (RBs).

Furthermore, the scheduler unit 25 selects the above-described target terminal device by using the channel estimation value received from the communication device 3. Further, the scheduler unit 25 uses the channel estimation value received from the communication device 2 to allocate, to the target terminal device, a wireless resource (for example, a resource specified by at least one of an antenna port, time, and frequency) for mapping the transmission signal addressed to the target terminal device. Then, the scheduler unit 25 generates “second wireless resource allocation information” including information related to the resource allocated to the target terminal device.

In addition, the scheduler unit 25 transmits the second wireless resource allocation information to the communication device 3, which is described later, through the interface 4. Note that, the first wireless resource allocation information and the second wireless resource allocation information may be included in a management message used between the communication device 2 and the communication device 3, and transmitted from the communication device 2 to the communication device 3. In addition, in a case where the interface 4 is a fronthaul or an open fronthaul, the first wireless resource allocation information and the second wireless resource allocation information may be transmitted from the communication device 2 to the communication device 3 by using a C-plane included in the fronthaul or open fronthaul. Furthermore, various kinds of information transmitted and received by the scheduler unit 25 may be data-compressed. For example, the first wireless resource allocation information and the second wireless resource allocation information transmitted by the scheduler unit 25 may be data-compressed. Thus, the transmission band in the interface 4 can be reduced.

In FIG. 3, the communication device 3 includes a beamforming weight multiplication unit 31, an inverse fast Fourier transform unit (IFFT) 32, a wireless unit (TRX) 33, a fast Fourier transform unit (FFT) 34, a beamforming weight multiplication unit 35, a channel estimation unit 36, a beamforming weight generation unit 37, and N antennas 38.

The beamforming weight multiplication unit 31 receives a transmission beam weight to be used for the target terminal device from the beamforming weight generation unit 37. The transmission beam weight is, for example, a matrix of N rows and L columns. Then, the beamforming weight multiplication unit 31 acquires N transmission signal sequences by multiplying L transmission sequences received from the communication device 2 by the transmission beam weight. Each of the N transmission signal sequences is an IQ sample sequence of an OFDM signal in the frequency domain. N is the number of antennas included in the communication device 2, and is a natural number equal to or greater than 2. The beamforming weight multiplication unit 31 outputs the acquired N transmission signal sequences to the inverse fast Fourier transform unit 32.

The inverse fast Fourier transform unit 32 acquires N transmission signal sequences in the time domain by performing an inverse fast Fourier transform on the N transmission signal sequences in the frequency domain received from the beamforming weight multiplication unit 31. Each of the N transmission signal sequences in the time domain is an OFDM signal in the time domain. Further, the inverse fast Fourier transform unit 32 outputs the N transmission signal sequences in the time domain to the wireless unit 33.

The wireless unit 33 receives the N transmission signal sequences in the time domain from the inverse fast Fourier transform unit 32, and converts the N transmission signal sequences in the time domain into N sequences of wireless transmission signals. The N sequences of wireless transmission signals are transmitted from each of the N antennas 38.

Further, the wireless unit 33 performs reception wireless processing (for example, down-conversion, analog-to-digital conversion, or the like) on the N sequences of wireless reception signals received by the N antennas, and converts the wireless reception signals into N reception signal sequences in the time domain. The N reception signal sequences in the time domain are baseband signals. Further, the wireless unit 33 outputs the acquired N reception signal sequences in the time domain to the fast Fourier transform unit 34. Each of the N reception signal sequences in the time domain is an OFDM signal in the time domain.

The fast Fourier transform unit 34 acquires N reception signal sequences in the frequency domain by performing fast Fourier on the N reception signal sequences in the time domain received from the wireless unit 33. Each of the N reception signal sequences in the frequency domain is an OFDM signal in the frequency domain. The fast Fourier transform unit 34 outputs the acquired N reception signal sequences in the frequency domain to the beamforming weight multiplication unit 35.

The beamforming weight multiplication unit 35 receives the reception beam weight from the beamforming weight generation unit 37. The reception beam weight is, for example, a matrix of M rows and N columns. Then, the beamforming weight multiplication unit 35 acquires M (M is a natural number) (that is, M layers) reception sequences by multiplying the N reception signal sequences in the frequency domain received from the fast Fourier transform unit 34 by the reception beam weight. Each of the M reception sequences may be an IQ sample sequence.

Furthermore, the beamforming weight multiplication unit 35 outputs the acquired M reception sequences. The M reception sequences output from the beamforming weight multiplication unit 35 are transferred to the communication device 2 through the interface 4.

The channel estimation unit 36 receives the above-described first wireless resource allocation information. Then, based on the first wireless resource allocation information, the channel estimation unit 36 extracts a reference signal from the N reception signal sequences in the frequency domain output from the fast Fourier transform unit 34. For example, since the resource to which the reference signal is mapped is known based on the above-described “first parameter group”, the channel estimation unit 36 can extract the reference signal from the N reception signal sequences in the frequency domain.

Then, the channel estimation unit 36 calculates a channel estimation value, based on the first wireless resource allocation information and the extracted reference signal. For example, the channel estimation unit 36 forms a reference signal replica, based on the above-described “second parameter group”. Then, the channel estimation unit 36 compares the extracted reference signal with the formed reference signal replica to acquire fading, interference components, noise components, and the like in the space between the communication device 3 and the target terminal device, and calculates a channel estimation value (that is, a channel estimation matrix) in such space.

For example, the reference signal replica is formed based on the “second parameter group” as follows. As described above, the “second parameter group” includes the transmission comb number K_{TC}, the cyclic shift number n_{CS}, and the hopping coefficients u and v.

That is, first, the channel estimation unit 36 calculates the cyclic shift maximum value N_{CS}, a ZC code length N_{ZC}, and sequence coefficients q and p from the “second parameter group”. The cyclic shift maximum value N_{CS} is, for example, any value among 8, 12, and 16 for each value of the transmission comb number K_{TC}. The ZC code length N_{ZC} is, for example, the largest prime number that does not exceed 12 N_{BW}/K_{TC}. In addition, the sequence coefficients q and p are values determined by the following equations (1) and (2), for example.

$$[ Mathematical formula 1 ]$$

$$q = ⌊ p + \frac{1}{2} ⌋ + {v ( - 1 )}^{⌊ 2 p ⌋} \qquad ( 1 )$$

$$[ Mathematical formula 2 ]$$

$$p = \frac{{N}_{ZC} ( u + 1 )}{31} \qquad ( 2 )$$

Furthermore, the channel estimation unit 36 can calculate a pattern x(n) of the reference signal replica by substituting the acquired value and the second parameter group into the following equation (3).

$$[ Mathematical formula 3 ]$$

$$x ( n ) = {e}^{j 2 π \frac{{n}_{CS}}{{N}_{CS}} k} {e}^{- j \frac{π qm ( m + 1 )}{{N}_{ZC}}} \qquad ( 3 )$$

Note that m in equation (3) can be expressed by the following equation (4), for example.

$$[ Mathematical formula 4 ]$$

$$m = k mod {N}_{ZC} \qquad ( 4 )$$

The channel estimation unit 36 outputs the calculated channel estimation value to the beamforming weight generation unit 37. Further, the channel estimation unit 36 transmits the calculated channel estimation value to the communication device 2 via the interface 4. Note that various kinds of information transmitted and received by the channel estimation unit 36 may be data compressed. For example, the channel estimation unit 36 compresses the channel estimation value to be transmitted and transmits the compressed data to the communication device 2. Thus, the transmission band in the interface 4 can be reduced.

The beamforming weight generation unit 37 generates, for the terminal device indicated by the second wireless resource allocation information, beamforming weights (the above-described transmission beam weights and the above-described reception beam weights) to be used for the target terminal device, based on the channel estimation value received from the channel estimation unit 36. As described above, each of the transmission beam weight and the reception beam weight is, for example, a matrix indicating a beamforming weight. For example, in a case of generating a transmission beam weight matrix, when the number of antennas 38 is N and the number of layers of the transmission signal received by the beamforming weight multiplication unit 31 is L, the transmission beam weight may be a matrix of N rows and L columns. Further, in a case of generating a reception beam weight, when the number of antennas 38 is N and the number of layers of the reception signal generated by the beamforming weight multiplication unit 35 is M, the reception beam weight matrix may be a matrix of M rows and N columns.

Furthermore, the beamforming weight generation unit 37 outputs the generated transmission beam weight to the beamforming weight multiplication unit 31, and outputs the generated reception beam weight to the beamforming weight multiplication unit 35.

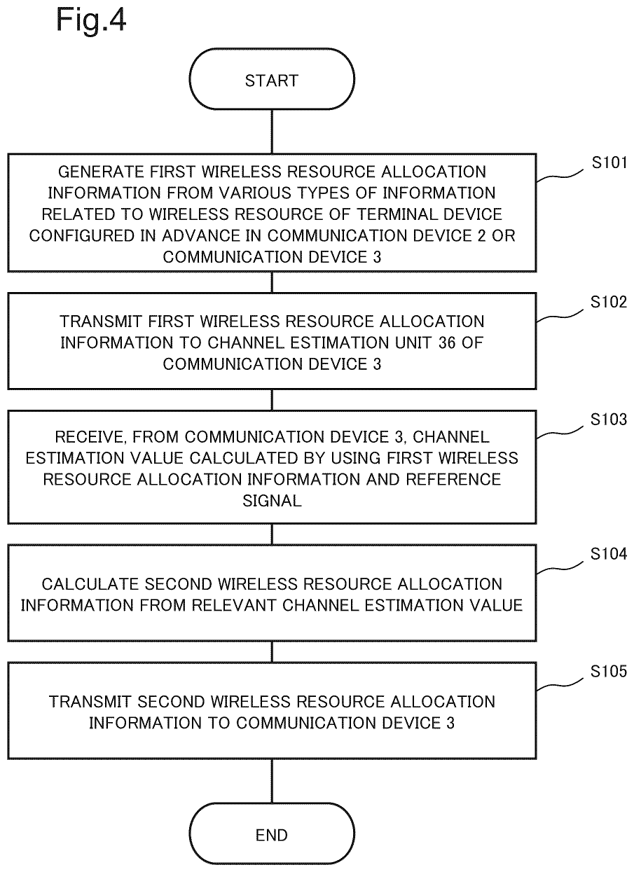

Next, an operation example of the communication device 2 according to the first example embodiment is described with reference to FIG. 4. FIG. 4 is a sequence diagram illustrating an operation example of the communication device 2 according to the first example embodiment.

The scheduler unit 25 of the communication device 2 generates the first wireless resource allocation information from various types of information related to the wireless resources of the terminal device configured in advance in the communication device 2 or the communication device 3 (S101).

The scheduler unit 25 of the communication device 2 transmits the first wireless resource allocation information to the channel estimation unit 36 of the communication device 3 (S102).

The scheduler unit 25 of the communication device 2 receives, from the communication device 3, the channel estimation value calculated using the first wireless resource allocation information and the reference signal (S103).

The scheduler unit 25 of the communication device 2 calculates the second wireless resource allocation information from the channel estimation value (S104).

The scheduler unit 25 of the communication device 2 transmits the second wireless resource allocation information to the communication device 3 (S105).

Of course, the above-described operations may be performed alone or in combination as appropriate. Accordingly, the communication device 2 can transmit information necessary for beamforming to the communication device 3 while avoiding compression of the bandwidth of the interface 4.

### Modification Example

<1> In the above description, description is made on the assumption that the scheduler unit 25 transmits the “first parameter group” and the “second parameter group” to the communication device 3, and the channel estimation unit 36 of the communication device 3 calculates the cyclic shift maximum value N_{CS}, the ZC code length N_{ZC}, and the sequence coefficients q and p by using the “second parameter group”. Then, the channel estimation unit 36 calculates the pattern of the reference signal replica by using the cyclic shift maximum value N_{CS}, the ZC code length N_{ZC}, and the sequence coefficients q and p, but the present invention is not limited thereto.

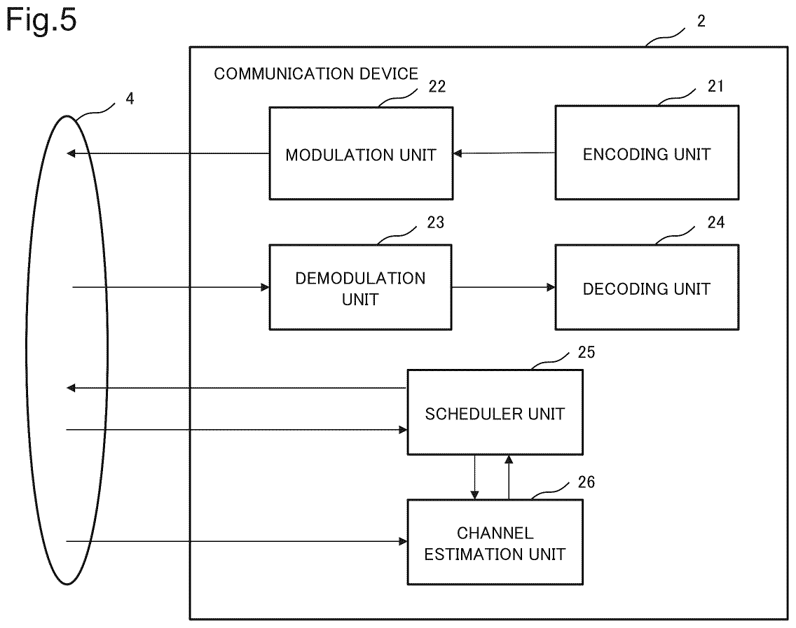

For example, the scheduler unit 25 may transmit, to the communication device 3, the cyclic shift maximum value N_{CS} and the ZC code length N_{ZC} in addition to the “second parameter group”, and the channel estimation unit 36 of the communication device 3 may calculate the sequence coefficients q and p by using the “second parameter group”. Then, the channel estimation unit 36 may calculate the pattern of the reference signal replica by using the cyclic shift maximum value N_{CS}, the ZC code length N_{ZC}, and the sequence coefficients q and p. It should be noted that, in this case as well, the scheduler unit 25 transmits the “first parameter group” to the communication device 3.

<2> Further, for example, the scheduler unit 25 may calculate the sequence coefficients q and p, based on the “second parameter group”. Then, the scheduler unit 25 may transmit the second parameter group that includes the sequence coefficients q and p instead of the hopping coefficients u and v to the communication device 3, and the channel estimation unit 36 of the communication device 3 may calculate the pattern of the reference signal replica by using such second parameter group. Thus, the processing load of the communication device 3 can be suppressed. It should be noted that, in this case as well, the scheduler unit 25 transmits the “first parameter group” to the communication device 3.
<3> Further, for example, instead of transmitting the second parameter group, the scheduler unit 25 may form a pattern of the reference signal replica and transmit the formed pattern of the reference signal replica to the communication device 3. Then, the channel estimation unit 36 may calculate the channel estimation value by using the pattern of the reference signal replica received from the scheduler unit 25. Thus, the processing load of the communication device 3 can be suppressed. It should be noted that, in this case as well, the scheduler unit 25 transmits the “first parameter group” to the communication device 3.
<4> Further, for example, when there are a plurality of target terminal devices to which the communication device 2 and the communication device 3 communicate, the channel estimation unit 36 may calculate a plurality of channel estimation values for the terminal devices by using signals received from each of the terminal devices. Then, the communication device 2 or the communication device 3 may associate the plurality of channel estimation values with relative target terminal devices and store such values in a memory included in the communication device 2 or the communication device 3. Furthermore, the scheduler unit 25 may allocate the plurality of target terminal devices to wireless resources, and transmit the allocation status of the target terminal device to the wireless resource as the second wireless resource allocation information to the communication device 3. In addition, the beamforming weight generation unit 37 may call a channel estimation value associated with each target terminal device from a memory included in the communication device 2 or the communication device 3 for a plurality of terminal devices indicated by the second wireless resource allocation information, and generate a beamforming weight, based on the channel estimation value. Accordingly, communication more suitable for each terminal device can be performed.
<5> Further, for example, the communication device 2 may include a channel estimation unit 26 separately from the channel estimation unit 36 included in the communication device 3. That is, both the communication device 2 and the communication device 3 may include a channel estimation unit. FIG. 5 illustrates a configuration example in which the communication device 2 includes the channel estimation unit 26. In such a case, the channel estimation unit 26 receives the first wireless resource allocation information from the scheduler unit 25 in a manner similar to that of the channel estimation unit 36 described above. In addition, the channel estimation unit 26 receives N reception signals in the frequency domain being output from the fast Fourier transform unit 34 through the interface 4. Then, for example, the reference signal is extracted from the reception signal and the channel estimation value is calculated, in a manner similar to that of the channel estimation unit 36 described above. Then, channel estimation unit 26 transmits the channel estimation value to the scheduler unit 25. In addition, the scheduler unit may generate the second wireless resource allocation information by using the channel estimation value calculated by the channel estimation unit 26. The channel estimation unit 26 may calculate a channel estimation value different from the value calculated by the channel estimation unit 36, by using a parameter or a method different from that of the channel estimation unit 36. That is, for example, various parameters having values different from those used when the channel estimation unit 36 calculates the channel estimation value may be used. Accordingly, the channel estimation value used by the scheduler unit 25 and the channel estimation value used by the beamforming weight generation unit 37 can be separated, and a channel estimation value suitable for each communication device from the viewpoint of resolution and smoothing can be used.

### Second Example Embodiment

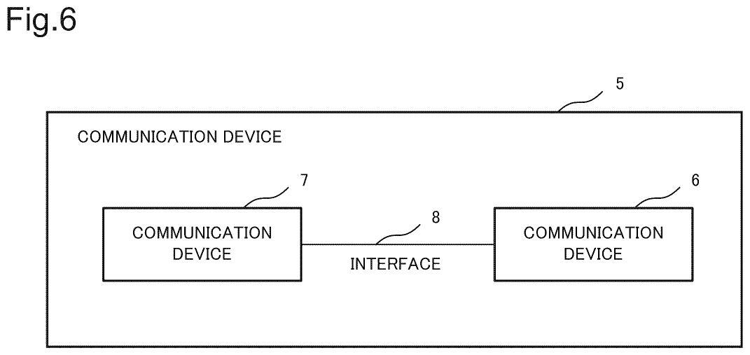

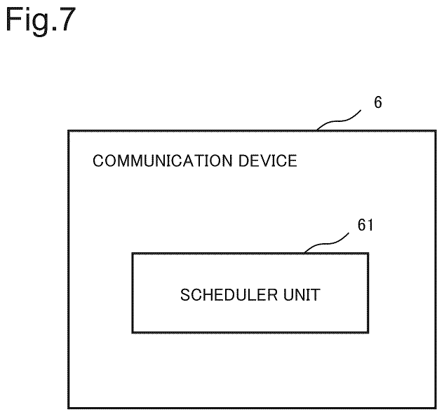

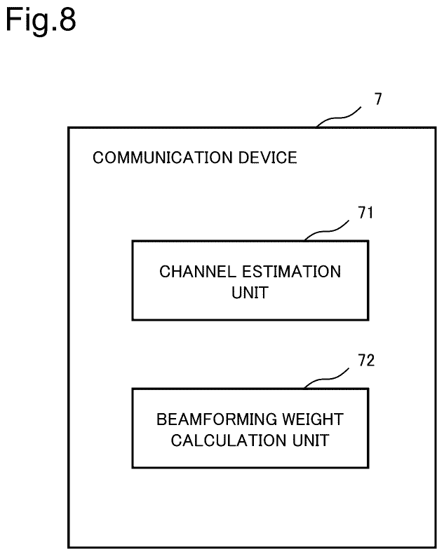

FIG. 6 illustrates a configuration example of a communication device 5 according to the present example embodiment, FIG. 7 illustrates a configuration example of a communication device 6 according to the present example embodiment, and FIG. 8 illustrates a configuration example of a communication device 7 according to the present example embodiment. The communication device 5 is relevant to the communication device 1 according to the first example embodiment, the communication device 6 is relevant to the communication device 2 according to the first example embodiment, and the communication device 7 is relevant to the communication device 3 according to the first example embodiment. An interface 8 is relevant to the interface 4 according to the first example embodiment.

In FIG. 7, the communication device 6 includes a scheduler unit 61.

The scheduler unit 61 is configured to transmit, to the communication device 7 via the interface 8, for example, information related to a reference signal transmitted from the terminal device.

The scheduler unit 61 receives, from the communication device 7 via the interface 8, for example, a channel estimation value related to a channel between the terminal device and the communication device 7, calculated by the communication device 7 by using a reception reference signal associated with the information related to the reference signal described above.

The scheduler unit 61 determines a resource to be allocated to communication with the terminal device, based on the above-described channel estimation value.

In FIG. 8, the communication device 7 includes a channel estimation unit 71 and a beamforming weight calculation unit 72.

The channel estimation unit 71 is configured to receive, from the communication device 6 via the interface 8, information related to the reference signal transmitted from the terminal device.

The channel estimation unit 71 calculates a channel estimation value related to a channel between the terminal device and the communication device 7 by using the reception reference signal associated with the above-described information related to the reference signal.

The beamforming weight calculation unit 72 is configured to calculate the beamforming weight used for communication with the terminal device, based on the above-described channel estimation value.

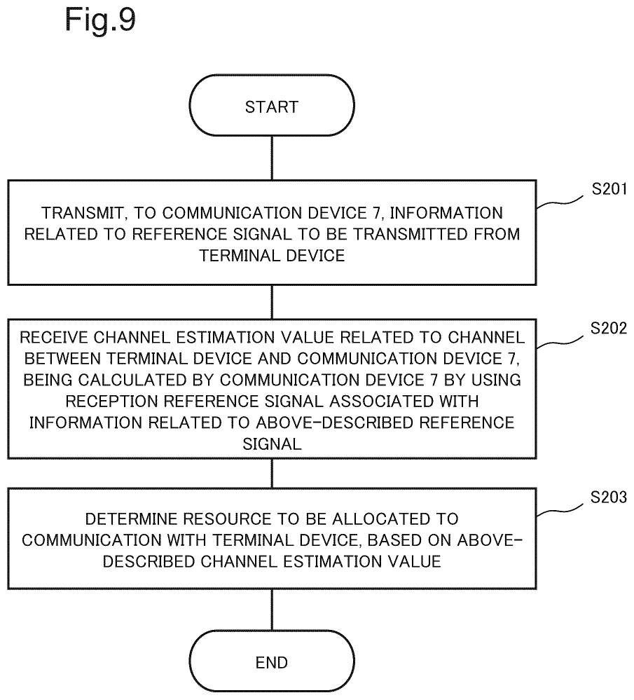

Next, an operation example of the communication device 6 according to the second example embodiment is described with reference to FIG. 9. FIG. 8 is a sequence diagram illustrating an operation example of the communication device 6 according to the second example embodiment.

The scheduler unit 61 of the communication device 6 transmits information related to the reference signal transmitted from the terminal device to the communication device 7 (S201).

The scheduler unit 61 of the communication device 6 receives the channel estimation value related to the channel between the terminal device and the communication device 7, calculated by the communication device 7 by using the reception reference signal associated with the information related to the above-described reference signal (S202).

A scheduler unit 63 of the communication device 6 determines a resource to be allocated to communication with the terminal device, based on the above-described channel estimation value (S203).

Needless to say, the above-described operations may be performed alone or in combination as appropriate. Accordingly, the communication device 6 can transmit information necessary for beamforming to the communication device 7 while avoiding the compression of the bandwidth of the interface 8.

### Other Example Embodiments

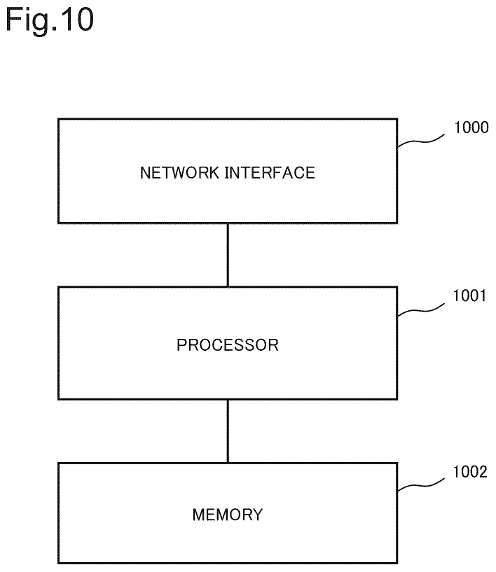

The communication devices 1, 2, 3, 5, 6, and 7 (hereinafter, referred to as the communication device 1 and the like) according to the above-described example embodiments may have the following hardware configuration. FIG. 10 is a block diagram illustrating an example of a hardware configuration of a computer (information processing device) capable of achieving the communication device according to each example embodiment.

Referring to FIG. 10, the communication device 1 and the like include a network interface 1000, a processor 1001, and a memory 1002. The network interface 1000 is being used to communicate with other wireless communication devices including a plurality of communication terminals. The network interface 1000 may include, for example, a network interface card (NIC) compliant with IEEE 802.11 series, IEEE 802.3 series, or the like.

The processor 1001 reads and implements software (computer program) from the memory 1002 and thereby executes processing of the communication device 1 and the like described with reference to the flowcharts and the sequence diagrams in the above-described example embodiments. The processor 1001 may be, for example, a microprocessor, a micro processing unit (MPU), or a central processing unit (CPU). The processor 1001 may include a plurality of processors.

The memory 1002 is configured of a combination of a volatile memory and a non-volatile memory. The memory 1002 may include a storage located remotely from the processor 1001. In such a case, the processor 1001 may access the memory 1002 via an I/O interface (not illustrated).

In the example of FIG. 10, the memory 1002 is being used to store software modules. The processor 1001 is able to read and implement the software modules from the memory 1002 and thereby execute the processing of the communication device 1 and the like described in the above-described example embodiments.

As described with reference to FIG. 10, each of the processors included in the communication device 1 or the like executes one or more programs including instructions for causing a computer to perform the algorithm described with reference to the drawings.

In the examples described above, the programs may be stored and provided to the computer by using various types of non-transitory computer-readable media. Non-transitory computer-readable media include various types of tangible storage media. Examples of non-transitory computer-readable media include a magnetic recording medium (e.g., a flexible disk, a magnetic tape, and a hard disk drive), and a magneto-optical recording medium (e.g., a magneto-optical disk). Further, examples of non-transitory computer-readable media include a CD-read only memory (ROM), a CD-R, and a CD-R/W. In addition, examples of non-transitory computer-readable media include a semiconductor memory. The semiconductor memory includes, for example, a mask ROM, a programmable ROM (PROM), an erasable PROM (EPROM), a flash ROM, and a random access memory (RAM). The program may also be provided to the computer by various types of transitory computer-readable media. Examples of transitory computer-readable media include electrical signals, optical signals, and electromagnetic waves. The transitory computer-readable medium may supply the program to the computer via a wired communication path such as an electric wire and an optical fiber, or a wireless communication path.

Note that, the present disclosure is not limited to the above-described example embodiments, and can be appropriately modified without departing from the scope of the present disclosure. Further, the present disclosure may be implemented by appropriately combining each of the example embodiments.

For example, some or all of the above-described example embodiments may be described as the following supplementary notes, but are not limited thereto.

### Supplementary Note 1

A first communication device among the first communication device and a second communication device that are connected to each other via an interface and to which base station functions are distributed,
the second communication device including a beamforming weight calculation unit and a channel estimation unit,
the first communication device including a scheduler configured to:
   transmit, to the second communication device via the interface, information related to a reference signal to be transmitted from a terminal device;
   receive, via the interface, a channel estimation value related to a channel between the terminal device and the second communication device, being calculated by the second communication device by using a reception reference signal associated with information related to the reference signal; and
   determine a resource to be allocated to communication with the terminal device, based on the channel estimation value.

### Supplementary Note 2

The first communication device according to supplementary note 1, wherein the information related to the reference signal includes at least one of a pattern of the reference signal and information necessary for calculating the pattern of the reference signal.

### Supplementary Note 3

The first communication device according to supplementary note 2, wherein the information necessary for calculating the pattern includes at least one of a symbol number of a time axis slot being a start position of a time axis in the reference signal, a frequency start position of the reference signal, a bandwidth of the reference signal, a transmission comb number, a hopping coefficient, a cyclic shift number, a ZC code length, and a sequence coefficient.

### Supplementary Note 4

The first communication device according to supplementary note 1, wherein the first communication device is a radio unit (RU) constituting the base station, and the second communication device is a distributed unit (DU) constituting the base station.

### Supplementary Note 5

A second communication device among a first communication device and the second communication device that are connected to each other via an interface and to which base station functions are distributed, the second communication device including:
a channel estimation unit configured to receive, from the first communication device via the interface, information related to a reference signal to be transmitted from a terminal device and calculate a channel estimation value related to a channel between the terminal device and the second communication device by using a reception reference signal associated with information related to the reference signal; and
a beamforming weight calculation unit configured to calculate, based on the calculated channel estimation value, a beamforming weight to be used for communication with the terminal device.

### Supplementary Note 6

The second communication device according to supplementary note 5, further comprising a transmission unit configured to compress the channel estimation value and transmit the compressed channel estimation value to the first communication device.

### Supplementary Note 7

A first communication device among the first communication device and a second communication device that are connected to each other via an interface and to which base station functions are distributed,
the second communication device including a beamforming weight calculation unit and a first channel estimation unit,
the first communication device including:
   a second channel estimation unit configured to calculate a second channel estimation value from a reference signal received from the second communication device; and
   a scheduler configured to perform allocation to a wireless resource of a terminal device for beamforming, based on the second channel estimation value, and transmit information indicating a result of the allocation to the second communication device via the interface.

### Supplementary Note 8

A method of a first communication device among the first communication device and a second communication device that are connected to each other via an interface and to which base station functions are distributed,
the second communication device including a beamforming weight calculation unit and a channel estimation unit,
the method of the first communication device including:
   transmitting, to the second communication device via the interface, information related to a reference signal to be transmitted from a terminal device;
   receiving, via the interface, a channel estimation value related to a channel between the terminal device and the second communication device, being calculated by the second communication device by using a reception reference signal associated with information related to the reference signal; and
   determining a resource to be allocated to communication with the terminal device, based on the channel estimation value.

### Supplementary Note 9

A method of a second communication device among a first communication device and the second communication device that are connected to each other via an interface and to which base station functions are distributed, the method of the second communication device including:
receiving, from the first communication device via the interface, information related to a reference signal to be transmitted from a terminal device;
calculating a channel estimation value related to a channel between the terminal device and the second communication device by using a reception reference signal associated with information related to the reference signal; and
calculating, based on the calculated channel estimation value, a beamforming weight to be used for communication with the terminal device.

### Supplementary note 10

A method of a first communication device among the first communication device and a second communication device that are connected to each other via an interface and to which base station functions are distributed,
the second communication device including a beamforming weight calculation unit and a first channel estimation unit,
the method of the first communication device including:
   calculating a second channel estimation value from a reference signal received from the second communication device;
   performing allocation to wireless resources of a terminal device for beamforming, based on the second channel estimation value; and
   transmitting information indicating a result of the allocation to the second communication device via the interface.

### Supplementary Note 11

A computer-readable recording medium storing a program of a first communication device among the first communication device and a second communication device that are connected to each other via an interface and to which base station functions are distributed,
the second communication device including a beamforming weight calculation unit and a channel estimation unit,
the program causing the first communication device to execute:
   transmitting, to the second communication device via the interface, information related to a reference signal to be transmitted from a terminal device;
   receiving, via the interface, a channel estimation value related to a channel between the terminal device and the second communication device, being calculated by the second communication device by using a reception reference signal associated with information related to the reference signal; and
   determining a resource to be allocated to communication with the terminal device, based on the channel estimation value.

### Supplementary Note 12

A computer-readable recording medium storing a program of a second communication device among a first communication device and the second communication device that are connected to each other via an interface and to which base station functions are distributed,
the program causing the second communication device to execute:
   receiving, from the first communication device via the interface, information related to a reference signal to be transmitted from a terminal device;
   calculating a channel estimation value related to a channel between the terminal device and the second communication device by using a reception reference signal associated with information related to the reference signal; and
   calculating, based on the calculated channel estimation value, a beamforming weight to be used for communication with the terminal device.

### Supplementary Note 13

A computer-readable recording medium storing a program of a first communication device among the first communication device and a second communication device that are connected to each other via an interface and to which base station functions are distributed,
the second communication device including a beamforming weight calculation unit and a first channel estimation unit,
the program causing the first communication device to execute:
   calculating a second channel estimation value from a reference signal received from the second communication device;
   performing allocation to a wireless resource of a terminal device for performing beamforming, based on the second channel estimation value; and
   transmitting information indicating a result of the allocation to the second communication device via the interface.

### REFERENCE SIGNS LIST

1, 2, 3, 5, 6, 7 COMMUNICATION DEVICE
4 INTERFACE
8 INTERFACE
21 ENCODING UNIT
22 MODULATION UNIT
23 DEMODULATION UNIT
24 DECODING UNIT
25 SCHEDULER UNIT
26 CHANNEL ESTIMATION UNIT
31 BEAMFORMING WEIGHT MULTIPLICATION UNIT
32 INVERSE FAST FOURIER TRANSFORM UNIT
33 WIRELESS UNIT
34 FAST FOURIER TRANSFORM UNIT
35 BEAMFORMING WEIGHT MULTIPLICATION UNIT
36 CHANNEL ESTIMATION UNIT
37 BEAMFORMING WEIGHT GENERATION UNIT
38 ANTENNA
61, 63 SCHEDULER UNIT
71 CHANNEL ESTIMATION UNIT
72 BEAMFORMING WEIGHT CALCULATION UNIT
1000 NETWORK INTERFACE
1001 PROCESSOR
1002 MEMORY

What is claimed is:

1. A first communication device among the first communication device and a second communication device that are connected to each other via an interface and to which base station functions are distributed,
the second communication device including a beamforming weight calculation unit and a channel estimation unit,
the first communication device comprising-a scheduler configured to: one or more memories storing instructions and one or more processors configured to execute the instructions to:
transmit, to the second communication device via the interface, information related to a reference signal to be transmitted from a terminal device;
receive, via the interface, a channel estimation value related to a channel between the terminal device and the second communication device, being calculated by the second communication device by using a reception reference signal associated with information related to the reference signal; and
determine a resource to be allocated to communication with the terminal device, based on the channel estimation value.

2. The first communication device according to claim 1, wherein the information related to the reference signal includes at least one of a pattern of the reference signal and information necessary for calculating the pattern of the reference signal.

3. The first communication device according to claim 2, wherein the information necessary for calculating the pattern includes at least one of a symbol number of a time axis slot being a start position of a time axis in the reference signal, a frequency start position of the reference signal, a bandwidth of the reference signal, a transmission comb number, a hopping coefficient, a cyclic shift number, a ZC code length, and a sequence coefficient.

4. The first communication device according to claim 1, wherein the first communication device is a radio unit (RU) constituting the base station, and the second communication device is a distributed unit (DU) constituting the base station.

5. A second communication device among a first communication device and the second communication device that are connected to each other via an interface and to which base station functions are distributed, the second communication device comprising one or more memories storing instructions and one or more processors configured to execute the instructions to:
receive, from the first communication device via the interface, information related to a reference signal to be transmitted from a terminal device and calculate a channel estimation value related to a channel between the terminal device and the second communication device by using a reception reference signal associated with information related to the reference signal; and
calculate, based on the calculated channel estimation value, a beamforming weight to be used for communication with the terminal device.

6. The second communication device according to claim 5, wherein the one or more processors are configured to execute the instructions to compress the channel estimation value and transmit the compressed channel estimation value to the first communication device.

7. A method of a first communication device among the first communication device and a second communication device that are connected to each other via an interface and to which base station functions are distributed,
the second communication device including a beamforming weight calculation unit and a channel estimation unit,
the method of the first communication device comprising:
transmitting, to the second communication device via the interface, information related to a reference signal to be transmitted from a terminal device;
receiving, via the interface, a channel estimation value related to a channel between the terminal device and the second communication device, being calculated by the second communication device by using a reception reference signal associated with information related to the reference signal; and
determining a resource to be allocated to communication with the terminal device, based on the channel estimation value.

8. A method of a second communication device among a first communication device and the second communication device that are connected to each other via an interface and to which base station functions are distributed, the method of the second communication device comprising:
receiving, from the first communication device via the interface, information related to a reference signal to be transmitted from a terminal device;
calculating a channel estimation value related to a channel between the terminal device and the second communication device by using a reception reference signal associated with information related to the reference signal; and
calculating, based on the calculated channel estimation value, a beamforming weight to be used for communication with the terminal device.

9. A non-transitory computer-readable recording medium storing a program of a first communication device among the first communication device and a second communication device that are connected to each other via an interface and to which base station functions are distributed,
the second communication device including a beamforming weight calculation unit and a channel estimation unit,
the program causing the first communication device to execute:
transmitting, to the second communication device via the interface, information related to a reference signal to be transmitted from a terminal device;
receiving, via the interface, a channel estimation value related to a channel between the terminal device and the second communication device, being calculated by the second communication device by using a reception reference signal associated with information related to the reference signal; and
determining a resource to be allocated to communication with the terminal device, based on the channel estimation value.

10. A non-transitory computer-readable recording medium storing a program of a second communication device among a first communication device and the second communication device that are connected to each other via an interface and to which base station functions are distributed,
the program causing the second communication device to execute:
receiving, from the first communication device via the interface, information related to a reference signal to be transmitted from a terminal device;
calculating a channel estimation value related to a channel between the terminal device and the second communication device by using a reception reference signal associated with information related to the reference signal; and
calculating, based on the calculated channel estimation value, a beamforming weight to be used for communication with the terminal device.
